(19) United States
(12) Patent Application Publication
(10) Pub. No.: US 2025/0026617 A1
(43) Pub. Date: Jan. 23, 2025

(54) MANEUVERING ASSISTANCE SYSTEM AND WORK VEHICLE

(71) Applicant: TADANO LTD., Kagawa (JP)

(72) Inventors: Kohei MOTOKI, Kagawa (JP); Shinsuke KANDA, Kagawa (JP); Mizuki YONEDA, Kagawa (JP); Fumihiko FUTABA, Kagawa (JP)

(73) Assignee: TADANO LTD., Kagawa (JP)

(21) Appl. No.: 18/710,207

(22) PCT Filed: Nov. 29, 2022
(86) PCT No.: PCT/JP2022/044009

§ 371 Date: May 15, 2024

(30) Foreign Application Priority Data
Nov. 30, 2021 (JP) 2021-194526

(51) Int. Cl. B66C 13/46

(52) U.S. Cl. CPC B66C 13/46

(57) ABSTRACT

A maneuvering assistance system according to the present invention assists maneuvering of a work vehicle including a boom, said maneuvering assistance system comprising: a display that is transparent and that is capable of displaying an image; a generation unit that generates a virtual image indicating a target member including the boom and/or a member that moves together with the boom; and a control unit that displays the virtual image on the display in a superimposed manner on a landscape visible through the display in a mode in which a user of the display is capable of recognizing a position of the target member.

### TECHNICAL FIELD

The present invention relates to a maneuvering assistance system for a work vehicle and a work vehicle having the maneuvering assistance system.

### BACKGROUND ART

Conventionally, when a mobile crane that is a type of a work vehicle is used to carry a load, an operator of the mobile crane operates a plurality of operation tools including a slewing-dedicated operation tool, a derricking-movement-dedicated operation tool, a telescopic-movement-dedicated operation tool, which are for operating a boom of the mobile crane, and an operation tool for a winch for lifting up or down the load, for example. In addition, the operator is forced to simultaneously operate the plurality of operation tools to operate the mobile crane while paying attention to prevent the load from coming into contact with a structure in a work site, for example. Therefore, the operator acquires information about a position of the load and information about a planimetric feature, for example, from a slinging operator to supplement information about a range and time where and when the operator may not be capable of making visual recognition. That is, the operator maneuvers the crane based on information about those that the operator has visually recognized and information provided from an external instructor.

In addition, the mobile crane includes a boom camera, for example, for acquiring information about a region that the operator may be difficult to recognize from an operation seat. The mobile crane is capable of using the boom camera to acquire, from above, an image of a load being carried and a surrounding structure, for example. For example, Patent Literature 1 is exemplified.

A crane described in Patent Literature 1 uses a boom camera provided at a distal end of a boom to acquire an image of a work site and an image of a load that a hook is suspending, and displays, in the images, in a superimposed manner, at least one of a reference line centered on the load, a scale, a directed segment indicating a direction of movement of the load, a trajectory along which the load is capable of slewing, for example. The operator of the crane makes a comprehensive determination based on information about those that the operator themselves has visually recognized, information provided from an instructor, and information about the images that the boom camera has captured to maneuver the crane.

### CITATION LIST

### Patent Literature

Patent Literature 1: JP 2019-156538 A

### SUMMARY OF THE INVENTION

### Problems to be Solved by the Invention

When it is not capable of visually recognizing a distal end of a boom and a hook, for example, an operator of a crane operates the crane in accordance with content of an instruction that an instructor has provided and a timing instructed through the instruction. At this time, the operator of the crane estimates, from the content of the instruction that the instructor has provided, a positional relationship among a surrounding structure, the boom, and the hook, for example. Therefore, the operator of the crane may face difficulties in efficiently maneuvering the crane if the content of the instruction that the instructor has provided is not appropriate.

An object of the present invention is to provide a maneuvering assistance system and a work vehicle that make it possible to suppress an influence of information acquired from an instructor on maneuvering and to efficiently maneuver a crane.

### Solutions to Problems

The inventors have studied configurations of a maneuvering assistance system and a work vehicle that make it possible to suppress an influence of information acquired from an instructor on maneuvering and to efficiently maneuver a crane. As a result of intensive studies, the inventors have conceived configurations as described below.

In one aspect, a maneuvering assistance system according to the present invention assists maneuvering of a work vehicle including a boom, and the maneuvering assistance system includes:
a display that is transparent and that is capable of displaying an image;
a generation unit that generates a virtual image indicating a target member including the boom and/or a member that moves together with the boom; and
a control unit that displays the virtual image on the display in a superimposed manner on a landscape visible through the display in a mode in which a user of the display is capable of recognizing a position of the target member.

In another aspect, a work vehicle according to the present invention includes the maneuvering assistance system described above.

Technical terms used in the present specification are used for the purpose of defining only certain examples, and the technical terms are not intended to limit the present invention.

As used in the present specification, the term “and/or” includes a single component and all combinations of a plurality of components listed in an associated manner.

Although, when “including,” “comprising,” or “having,” and their variations are used in the present specification, it is specified that stated features, steps, elements, components, and/or their equivalents exist, it is possible to include one or more of steps, operations, elements, components, and/or their groups.

In the present specification, the terms “attached,” “connected,” “coupled,” and/or their equivalents are used in a broad sense and encompass attachment, connection, and coupling both “directly and indirectly”. Furthermore, the terms “connected” and “coupled” are not limited to physical or mechanical connections or couplings, but may include direct or indirect connections or couplings.

Unless defined otherwise, all the terms (including technical and scientific terms) used in the present specification have identical meanings to those commonly understood by one of ordinary skilled in the art to which the present invention belongs.

The terms defined in commonly used dictionaries should be interpreted as those having meanings that are consistent with those meanings in the context of the relevant art and the present disclosure, and are not to be interpreted in an ideal or overly formal sense unless expressly so defined in the present specification.

It is understood that many techniques and steps are disclosed in the description of the present invention. Each of them has an individual benefit and is also possible to be used with one or more, or possibly all, of other disclosed techniques.

Therefore, in the description of the present invention, all possible combinations of individual steps are not unnecessarily repeated for the sake of clarity. However, the present specification and the claims should be read with an understanding that all such combinations fall within the scope of the present invention.

In the present specification, embodiments of a maneuvering assistance system for a work vehicle, according to the present invention, and a work vehicle including the maneuvering assistance system will be described.

In the following description, many specific examples are described for providing a thorough understanding of the present invention. However, it will be apparent to those skilled in the art that the present invention is capable of being practiced without these specific examples.

Therefore, it should be considered that the disclosure described below is exemplified as mere examples of the present invention, and there is no intention of limiting the present invention to the certain embodiments illustrated with reference to the following drawings or description.

### [Virtual Image]

In the present specification, a virtual image is an image or a video other than a background (a landscape) in a transmissive display device, which a user is visually recognizing in the transmissive display device, and means a line, a figure, an image, a video, a three-dimensional image, and/or a three-dimensional video that the transmission type display device is displaying. That is, the virtual image is an image that is capable of being displayed without discomfort on the background in the transmissive display device, which the user is visually recognizing, when an image of an object that does not actually exist is converted into an image of a shape, when viewed from a viewpoint of the user. The virtual image is displayed in a superimposed manner on the background in the transmissive display device, which the user is visually recognizing in the transmissive display device. The virtual image includes a first virtual image, a second virtual image, a third virtual image, a fourth virtual image, and a fifth virtual image.

### [Viewpoint]

In the present specification, the viewpoint means a standing point when an object is viewed. The viewpoint of the user means a position of the user with respect to an object when the user is visually recognizing the object.

[Information about Virtual Image]

In the present specification, information about a virtual image means information necessary for displaying the virtual image on a display screen of the transmissive display device as an image, when viewed from the viewpoint of the user of the transmissive display device. The information about a virtual image includes coordinates of the virtual image and/or a state of display, for example.

### [Trajectory]

In the present specification, a trajectory means a figure that a continuous line forms to represent a set of a plurality of coordinates at which a reference member of a work vehicle passes when each of operation tools for the work vehicle is operated. In addition, the trajectory includes a figure that a continuous line forms to represent one acquired when a set of coordinates at which the reference member of the work vehicle passes when each of the operation tools is operated is converted into coordinates on a desired reference plane.

### [Communication Device]

In the present specification, a communication device means a device that allows information to be transmitted and received between an image processing device and a display-device-dedicated control device, between the image processing device and an input device, and between the image processing device and a control device for a work vehicle. The communication device may be configured integrally with the display-device-dedicated control device and the image processing device.

### [Reference Member]

In the present specification, a reference member is a member that moves as a boom that a work vehicle has moves, and is a member for which an imaging device provided to the boom captures an image. That is, the reference member is a member for which the imaging device recognizes its current position. The reference member is, for example, one of a main hook, a main hook block, a sub hook, and a sub hook block, which are suspended from a boom, a main wire rope, and a load that a hook (the main hook or the sub hook) is suspending.

### Effects of the Invention

According to the present invention, it is possible to provide a maneuvering assistance system and a work vehicle that make it possible to suppress an influence of information acquired from an instructor on maneuvering and to efficiently maneuver a crane.

### BRIEF DESCRIPTION OF DRAWINGS

FIG. 1 is a perspective view illustrating a user wearing a transmissive display device in a maneuvering assistance system for a work vehicle, according to a first embodiment of the present invention.

FIG. 2 is a perspective view illustrating the transmissive display device in the maneuvering assistance system for the work vehicle, according to the first embodiment of the present invention.

FIG. 3 is a block diagram illustrating the maneuvering assistance system for the work vehicle, according to the first embodiment of the present invention.

FIG. 4 is a side view illustrating a crane to which the maneuvering assistance system for the work vehicle, according to the first embodiment of the present invention, is coupled.

FIG. 5 is a control block diagram for the crane to which the maneuvering assistance system for the work vehicle, according to the first embodiment of the present invention, is coupled.

FIG. 6 is a block diagram when the maneuvering assistance system for the work vehicle, according to the first embodiment of the present invention, generates information necessary for displaying a virtual image.

FIG. 7 is a schematic view illustrating a state when the maneuvering assistance system for the work vehicle, according to the first embodiment of the present invention, is displaying a virtual image.

FIG. 8 is a schematic view illustrating a state when the maneuvering assistance system for the work vehicle, according to the first embodiment of the present invention, is displaying a virtual image in a state where it is impossible to visually recognize a part of a boom.

FIG. 9 is a block diagram when a maneuvering assistance system for a work vehicle, according to a second embodiment of the present invention, generates information necessary for displaying a virtual image.

FIG. 10 is a schematic view illustrating a state when the maneuvering assistance system for the work vehicle, according to the second embodiment of the present invention, is displaying a virtual image when a ground plane is set as a reference plane.

FIG. 11 is a schematic view illustrating a state when the maneuvering assistance system for the work vehicle, according to the second embodiment of the present invention, is displaying a virtual image when a reference plane including a distal end of the boom is set as a reference plane.

FIG. 12 is a block diagram when a maneuvering assistance system for a work vehicle, according to a third embodiment of the present invention, generates information necessary for displaying a virtual image.

FIG. 13 is a block diagram when a maneuvering assistance system for a work vehicle, according to a fourth embodiment of the present invention, generates information necessary for displaying a virtual image.

FIG. 14 is a block diagram when a maneuvering assistance system for a work vehicle, according to a fifth embodiment of the present invention, generates information necessary for displaying a virtual image.

### DESCRIPTION OF EMBODIMENTS

### First Embodiment

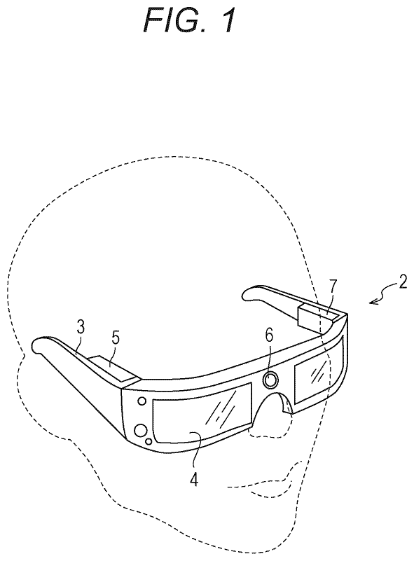

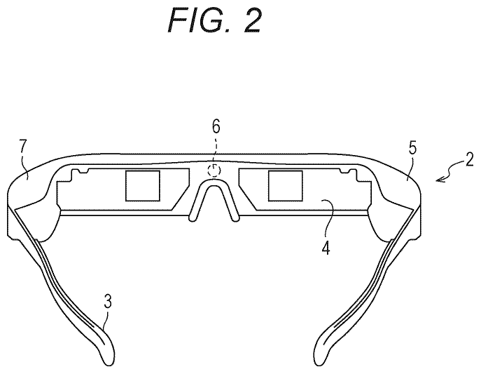

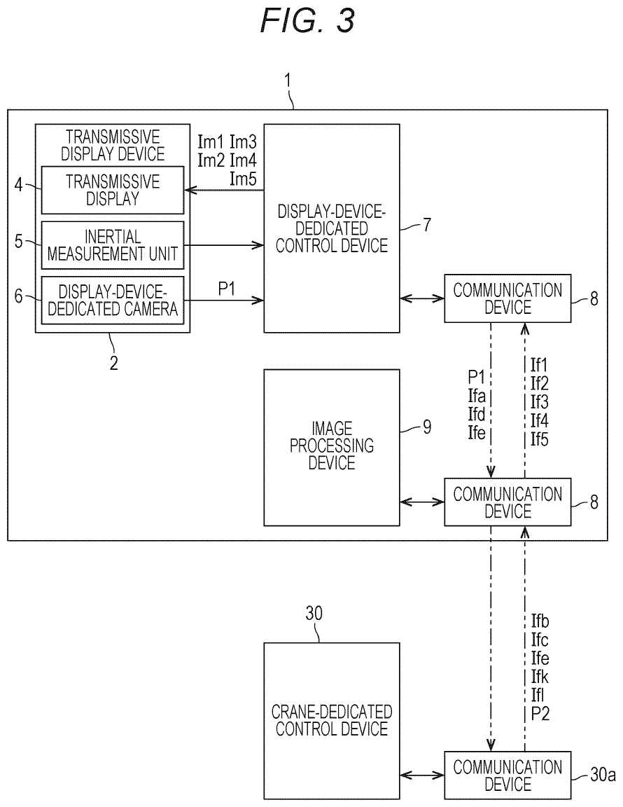

A maneuvering assistance system 1 for a crane 11 that is a work vehicle having a boom 19, according to a first embodiment of the present invention, will now be described herein with reference to FIGS. 1 to 3. FIG. 1 is a perspective view illustrating a user wearing a transmissive display device 2 in the maneuvering assistance system 1 for the crane 11, according to the first embodiment of the present invention. FIG. 2 is a perspective view illustrating the transmissive display device 2 in the maneuvering assistance system 1 for the crane 11. FIG. 3 is a block diagram illustrating the maneuvering assistance system 1 for the crane 11. Note that, in the present embodiment, a rough terrain crane (hereinafter simply referred to as a “crane”) will be described as a work vehicle. However, it is sufficient that the work vehicle be a work vehicle provided with a boom capable of performing derricking via a slewing table, such as an all-terrain crane, a truck crane, or a high-place work vehicle.

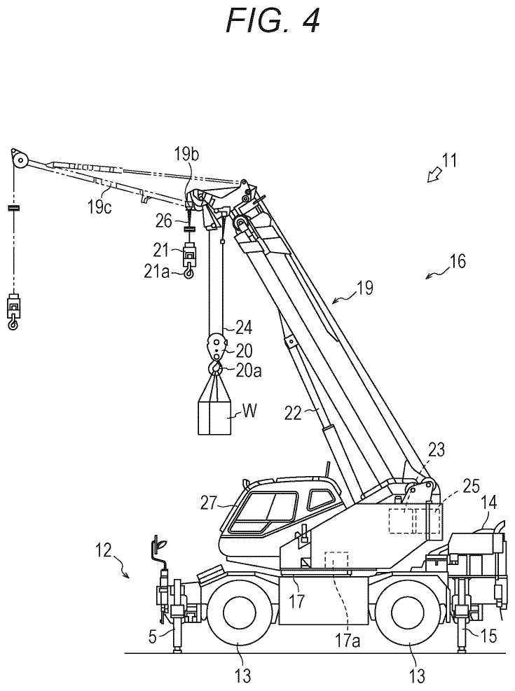

As illustrated in FIGS. 1 and 2, the maneuvering assistance system 1 for the crane 11 (see FIG. 4) that is a work vehicle is a system that uses mixed reality to assist maneuvering of the crane 11. The maneuvering assistance system 1 includes the transmissive display device 2, communication devices 8, and an image processing device 9.

The maneuvering assistance system 1 is a system that assists maneuvering of the crane 11 having the boom 19. The maneuvering assistance system 1 according to the present embodiment includes: a display (specifically, transmissive displays 4) that is transparent and that is capable of displaying an image; a generation unit (the image processing device 9) that generates a virtual image (specifically, a first virtual image Im1) indicating a target member including the boom 19 and/or a member (specifically, a wire rope and/or a hook) that moves together with the boom 19; and a control unit (a display-device-dedicated control device 7) that displays the virtual image on the image processing device 9 in a superimposed manner on a landscape visible through the image processing device 9 in a mode in which the user of the image processing device 9 is capable of recognizing a position of the target member. A specific configuration of the maneuvering assistance system 1 will now be described herein.

The transmissive display device 2 is a display device that allows the user to visually recognize a virtual image, when viewed from a viewpoint of the user of the transmissive display device 2, in a state of being superimposed on a background (a landscape) Ls in the transmissive display device 2, when viewed from the viewpoint of the user. The transmissive display device 2 is a wearable terminal that the user wears on its body and uses. In the present embodiment, the transmissive display device 2 will be described as an eyeglasses-type wearable terminal. An operator of the crane 11, who is also the user, wears the transmissive display device 2. The transmissive display device 2 includes a frame 3, the transmissive displays 4, an inertial measurement unit 5, a display-device-dedicated camera 6, and the display-device-dedicated control device 7.

The frame 3 supports the transmissive displays 4, the inertial measurement unit 5, the display-device-dedicated camera 6, and the display-device-dedicated control device 7. The frame 3 is configured as an eyeglasses-type frame. The user of the transmissive display device 2 wears the frame 3 on its head. The frame 3 is supported by a nose and both ears of the user.

The transmissive displays 4 are displays each having a transmittance of approximately 50% or higher. The transmissive displays 4 each include no backlight, no polarizing filter, and no color filter. The transmissive displays 4 may each be a liquid crystal display, an organic electroluminescence (EL) display, or an inorganic EL display, for example. That is, the transmissive displays 4 do not each include members such as a backlight and a filter that cover a back surface of each of display screens, which face the user, of the transmissive display device 2. Therefore, in the transmissive displays 4, the background that is superimposed on the transmissive displays 4 is transmissive, when viewed from the viewpoint of the user of the transmissive display device 2.

The transmissive displays 4 display, on the display screens, the first virtual image Im1, a second virtual image Im2, a third virtual image Im3, a fourth virtual image Im4, and a fifth virtual image Im5, which the display-device-dedicated control device 7 generates. Note that the first virtual image Im1 includes at least one of a first boom virtual image Im1a that is a virtual image of the boom 19 and a first reference member virtual image Im1b that is a virtual image of a reference member Rm. The first virtual image Im1 (the first boom virtual image Im1a and the first reference member virtual image Im1b) corresponds to an example of a virtual image indicating the target member.

The transmissive displays 4 each transmit light entering from the back surface at a portion where no virtual image is displayed. In addition, the transmissive displays 4 each block at least a part of light entering from the back surface, at a portion where a virtual image is displayed. Furthermore, the transmissive displays 4 each display a virtual image on the portion where light is blocked. At this time, a virtual image, when viewed from the viewpoint of the user of the transmissive display device 2, is displayed on each of the transmissive displays 4. Thereby, the transmissive displays 4 allow the user of the transmissive display device 2 to visually recognize a state in which the displayed virtual images are superimposed on the background Ls, when viewed from the viewpoint of the user of the transmissive display device 2. The transmissive displays 4 are provided on the frame 3.

The transmissive displays 4 are positioned so as to cover a visual field range of a right eye and a visual field range of a left eye of the user wearing the frame 3, respectively. The transmissive displays 4 are configured to be capable of displaying, as parallax images, a virtual image for the right eye and a virtual image for the left eye on the display screens, respectively. Thereby, the transmissive displays 4 are capable of displaying a stereoscopic virtual image in almost an entire visual field range of the user. Note that, in the transmissive display device 2, it is applied a known technique for displaying a virtual image, when viewed from the viewpoint of the user within a field of view of the user.

The inertial measurement unit (IMU) 5 calculates a position and an orientation of the transmissive display device 2. The inertial measurement unit 5 is positioned in the frame 3. The inertial measurement unit 5 calculates angles and angular accelerations around an X axis, a Y axis, and a Z axis. That is, the inertial measurement unit 5 uses a desired position as a reference to calculate a direction of movement and an amount of movement of the transmissive display device 2.

The display-device-dedicated camera 6 captures an image in a direction of a line of sight of the user wearing the transmissive display device 2. The display-device-dedicated camera 6 is provided in the frame 3. The display-device-dedicated camera 6 captures an image within a range substantially equal to the visual field range of the user from a position substantially equal to the viewpoint of the user of the transmissive display device 2. Note that, in the present embodiment, the display-device-dedicated camera 6 is provided in the frame 3, but may be provided at a position where it is possible to capture an image within the visual field range of the user of the transmissive display device 2 from the viewpoint of the user of the transmissive display device 2.

As illustrated in FIG. 3, the display-device-dedicated control device 7 is a control device that displays, on the transmissive displays 4, the first virtual image Im1, the second virtual image Im2, the third virtual image Im3, the fourth virtual image Im4, and the fifth virtual image Im5. Practically, a central processing unit (CPU), a read-only memory (ROM), a random access memory (RAM), and a hard disk drive (HDD), for example, are coupled to the display-device-dedicated control device 7 through a bus. Alternatively, the display-device-dedicated control device 7 may include a large-scale integrated circuit (LSI) in a form of a single chip, for example. The display device is coupled to the transmissive displays 4 and the display-device-dedicated camera 6. The display-device-dedicated control device 7 is coupled to the image processing device 9 via the communication devices 8.

The display-device-dedicated control device 7 is capable of acquiring a display device image P1 that the display-device-dedicated camera 6 captures. The display-device-dedicated control device 7 is capable of recognizing a certain marker that the display device image P1 includes. When coordinates of a certain marker have been acquired in advance, the display-device-dedicated control device 7 is capable of recognizing the certain marker to calculate a position and/or a posture of the display-device-dedicated camera 6, for example.

The certain marker is positioned at a predetermined location in a cabin 27 of the crane 11, which will be described later, for example. Furthermore, by using the position and/or the posture of the display-device-dedicated camera 6 as a reference, for example, which have been calculated based on the certain marker, the display-device-dedicated control device 7 uses the inertial measurement unit 5 to calculate the position and/or the posture of the display-device-dedicated camera 6 for each unit time. Thereby, when the display device image P1 captured previously has included the certain marker, the display-device-dedicated control device 7 is capable of calculating the current position and/or the current posture of the display-device-dedicated camera 6, for example, even in a state where the display device image P1 captured currently does not include the certain marker.

The display-device-dedicated camera 6 is used as a reference to determine in advance a position of the user of the transmissive display device 2. Therefore, the display-device-dedicated control device 7 is capable of generating, based on the calculated position and/or the calculated posture of the display-device-dedicated camera 6, for example, information Ifa about the position of the user of the transmissive display device 2. The information Ifa about the position of the user includes coordinate information including a latitude, a longitude, and an altitude, for example, at which the user of the transmissive display device 2 is positioned, and a direction of visual recognition of the user of the transmissive display device 2, for example. The transmissive display device 2 recognizes, for example, a marker positioned in the cabin 27 of the crane 11, which will be described later, to calculate the information Ifa about the position of the user of the transmissive display device 2.

The display-device-dedicated control device 7 acquires, from the image processing device 9, information If1 about the first virtual image Im1, information If2 about the second virtual image Im2, information If3 about the third virtual image Im3, information If4 about the fourth virtual image Im4, and/or information If5 about the fifth virtual image Im5, which the transmissive displays 4 display. Based on the information If1 about the first virtual image Im1, the information If2 about the second virtual image Im2, the information If3 about the third virtual image Im3, the information If4 about the fourth virtual image Im4, and/or the information If5 about the fifth virtual image Im5, which have been acquired, the display-device-dedicated control device 7 is capable of displaying, on the transmissive displays 4, the first virtual image Im1, the second virtual image Im2, the third virtual image Im3, the fourth virtual image Im4, and the fifth virtual image Im5, when viewed from the viewpoint of the user of the transmissive display device 2.

The transmissive display device 2 is capable of displaying the first virtual image Im1, the second virtual image Im2, the third virtual image Im3, the fourth virtual image Im4, and/or the fifth virtual image Im5 on the display screens of the transmissive displays 4 in a state of being worn by the user on its head. In addition, the transmissive display device 2 is capable of recognizing a certain marker to calculate the information Ifa about the position of the user, which is necessary for displaying the first virtual image Im1, the second virtual image Im2, the third virtual image Im3, the fourth virtual image Im4, and/or the fifth virtual image Im5 on the transmissive displays 4.

The transmissive display device 2 is capable of displaying, on the transmissive displays 4, at least one of the first virtual image Im1, the second virtual image Im2, the third virtual image Im3, the fourth virtual image Im4, and the fifth virtual image Im5, when viewed from the viewpoint of the user of the transmissive display device 2, on the display screens of the transmissive displays 4 on which the background Ls is transmissive. Thereby, the transmissive display device 2 allows the user of the transmissive display device 2 to visually recognize at least one of the first virtual image Im1, the second virtual image Im2, the third virtual image Im3, the fourth virtual image Im4, and the fifth virtual image Im5 in a state of being superimposed on the background Ls in the transmissive display device 2.

As illustrated in FIG. 3, the communication devices 8 are devices that each transmit and receive information among the transmissive display device 2, the image processing device 9, and a crane-dedicated control device 30. The communication devices 8 are provided in the display-device-dedicated control device 7 and the image processing device 9, respectively, for the transmissive display device 2. The communication devices 8 each allow information to be transmitted and received between the crane-dedicated control device 30 and the image processing device 9. In addition, the communication devices 8 each allow information to be transmitted and received between the display-device-dedicated control device 7 and the image processing device 9.

The image processing device 9 corresponds to an example of a generation unit, and is a control device that generates the information If1 about the first virtual image Im1, the information If2 about the second virtual image Im2, the information If3 about the third virtual image Im3, the information If4 about the fourth virtual image Im4, and the information If5 about the fifth virtual image Im5. A CPU, a ROM, a RAM, and an HDD, for example, are coupled to the image processing device 9 through a bus.

Alternatively, the image processing device 9 may include an LSI in a form of a single chip, for example. In the present embodiment, the image processing device 9 is provided in the transmissive display device 2. That is, the image processing device 9 is supported by the frame 3.

The image processing device 9 stores various types of programs and various types pieces of data for controlling operation of the transmissive display device 2 and for processing image data, for example. Note that the image processing device 9 may be configured integrally with the display-device-dedicated control device 7 or the crane-dedicated control device 30 for the crane 11 that is a work vehicle, which will be described later.

The image processing device 9 is coupled to the display-device-dedicated control device 7 for the transmissive display device 2 via the communication devices 8. The image processing device 9 is capable of acquiring the information Ifa about the position of the user from display-device-dedicated control device 7 via the communication devices 8. In addition, the image processing device 9 is capable of acquiring the display device image P1 that the display-device-dedicated camera 6 has captured from the display-device-dedicated control device 7 via the communication devices 8. In addition, the image processing device 9 is capable of acquiring, via the communication device 8, a reference member image P2 that is an image in which a predetermined range including the reference member Rm is captured, which a boom camera 19b (see FIG. 4) on the crane 11, which is an imaging device, has captured.

The image processing device 9 is capable of acquiring information Ifb about a position of the crane 11 from the crane-dedicated control device 30 via the communication device 8. The information Ifb about the position of the crane 11 includes coordinate information including a latitude, a longitude, and an altitude, for example, at which a center of slewing of the crane 11 is positioned, for example, and an orientation of a vehicle 12, for example.

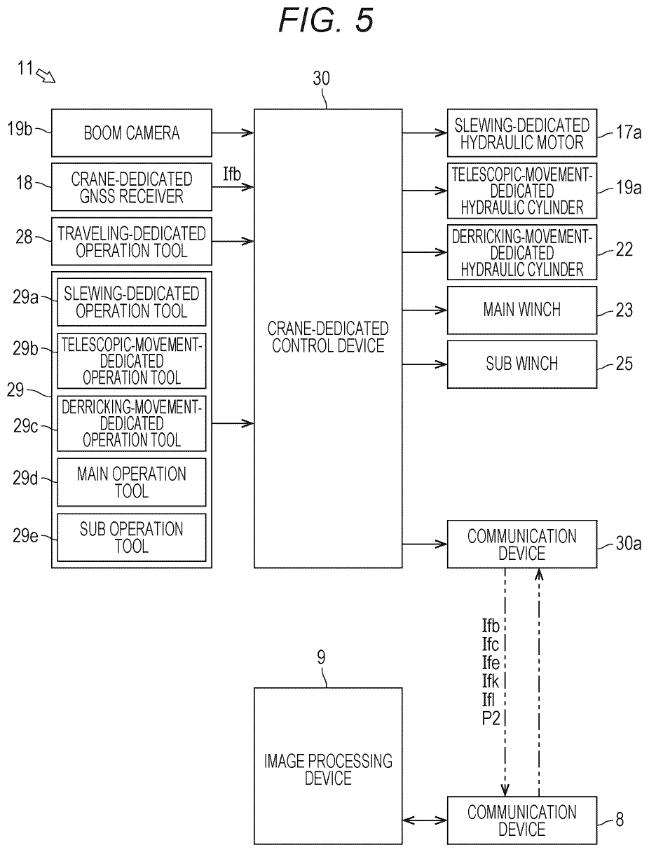

The image processing device 9 is capable of acquiring information Ifc about a posture of the crane 11 from the crane-dedicated control device 30 via the communication device 8. The information Ifc about the posture of the crane 11 includes specifications including an angle of slewing of the crane 11, an angle of derricking of the boom, a length of the boom, a length of feeding of a main wire rope 24, a length of feeding of a sub-wire rope 26, and an angle of view of the boom camera 19b, for example, and a direction of operation and an amount of operation of each of operation tools for the crane 11 (see FIGS. 4 and 5).

The image processing device 9 is capable of acquiring information Ifi about a shape of the crane 11 from the crane-dedicated control device 30 or a non-illustrated external server via the communication device 8. The information Ifi about the shape of the crane 11 is information about three-dimensional coordinates (in other words, a three-dimensional image) about the shapes of members about the boom 19, including the boom 19, a jib 19c, a main hook block 20, a main hook 20a, a sub hook block 21, a sub hook 21a, the main wire rope 24, and the sub wire rope 26, for example, which will be described later. In addition, the information Ifi about the shape of the crane 11 includes coordinate information including a latitude, a longitude, and an altitude of the boom camera 19b provided on the boom 19, for example, and a direction of imaging of the boom camera 19b, for example.

The image processing device 9 is capable of acquiring information Ifh about a shape of the reference member Rm from the crane-dedicated control device 30 or a BIM, for example, which an external server has, via the communication device 8. The reference member Rm includes the main hook block 20, the main hook 20a, the sub hook block 21, the sub hook 21a, the main wire rope 24, the sub wire rope 26, a load W, which move as the boom 19 moves, for example. The user of the transmissive display device 2 is capable of selecting the reference member Rm as desired. The information Ifh about the shape of the reference member Rm is information about three-dimensional coordinates (in other words, a three-dimensional image) about the reference member Rm. In the present embodiment, the main hook 20a serves as the reference member Rm.

The image processing device 9 is capable of acquiring information Iff about the reference member image P2 from the crane-dedicated control device 30 or the boom camera 19b that is an imaging device for the crane 11 via the communication device 8. The information Iff about the reference member image P2 includes the reference member image P2 that the boom camera 19b has captured and the angle of view of the boom camera 19b when the reference member image P2 is captured, for example. The information Iff about the reference member image P2 includes information Ifg about a posture of the reference member Rm.

The maneuvering assistance system 1 for the crane 11, which is configured as described above, uses the image processing device 9 to acquire the information Ifa about the position of the user of the transmissive display device 2, the information Ifb about the position of the crane 11, the information Ifc about the posture of the crane 11, the information Iff about the reference member image P2, and the information Ifi about the shape of the crane 11.

The crane 11 that is the work vehicle according to an embodiment of the present invention will now be described herein with reference to FIGS. 4 to 5. FIG. 4 is a side view illustrating the crane 11 to which the maneuvering assistance system 1 is coupled. FIG. 5 is a control block diagram for the crane 11 to which the maneuvering assistance system 1 is coupled.

As illustrated in FIGS. 4 and 5, the crane 11 is a mobile crane that is capable of moving to a desired place. The crane 11 includes the vehicle 12, a crane device 16, the boom camera 19b that is the imaging device, and the crane-dedicated control device 30.

The vehicle 12 is a travelling body that carries the crane device 16. The vehicle 12 has a plurality of wheels 13. The vehicle 12 uses an engine 14 as a power source to travel. The vehicle 12 includes outriggers 15. The outriggers 15 include extension beams that are extendable by using hydraulic pressure on both sides in a width direction of the vehicle 12 and hydraulic jack cylinders that are extendable in a direction perpendicular to a ground, respectively.

The crane device 16 is a work device that uses a wire rope to lift the load W. The crane device 16 includes a slewing table 17, a crane-dedicated global navigation satellite system (GNSS) receiver 18, the boom 19, the main hook block 20, the sub hook block 21, a derricking-movement-dedicated hydraulic cylinder 22, a main winch 23, the main wire rope 24, a sub winch 25, the sub wire rope 26, and the cabin 27, for example.

The slewing table 17 is a rotation device that allows the crane device 16 to slew. The slewing table 17 is provided on a frame of the vehicle 12 via an annular bearing. The slewing table 17 is configured to be rotatable about a center of the annular bearing, which serves as a center of rotation. The slewing table 17 includes a hydraulic, slewing-dedicated hydraulic motor 17a serving as an actuator. The slewing table 17 is configured to be capable of slewing in one direction and another direction with the slewing-dedicated hydraulic motor 17a.

The crane-dedicated GNSS receiver 18 is a receiver constituting a global navigation satellite system. The crane-dedicated GNSS receiver 18 receives, from a satellite, a radio wave for measuring a distance, and detects a latitude, a longitude, an altitude, and an orientation, for example, which form absolute coordinates of the crane-dedicated GNSS receiver 18. The crane-dedicated GNSS receiver 18 is provided on the slewing table 17. The crane-dedicated GNSS receiver 18 detects the information Ifb about the position of the crane 11.

The boom 19 is a movable support supporting the main wire rope 24 and the sub-wire rope 26. The boom 19 includes a plurality of boom members. A base end of a base boom member of the boom 19 is swingably provided at a substantially center of the slewing table 17. The boom 19 includes a telescopic-movement-dedicated hydraulic cylinder 19a that is an actuator for causing each of the boom members to extend and contract and the derricking-movement-dedicated hydraulic cylinder 22 for causing the boom members to raise and lower.

The telescopic-movement-dedicated hydraulic cylinder 19a causes the boom 19 to extend and contract in axial directions. The boom 19 includes the boom camera 19b serving as the imaging device. Furthermore, the boom 19 includes the jib 19c that is an extension member. The reference member image P2 that is an image that the boom camera 19b has captured is transmitted to the image processing device 9 via a communication device 30a for the crane-dedicated control device 30.

The main hook block 20 and the sub hook block 21 are components for suspending the load W. The main hook block 20 includes a plurality of hook sheaves, around which the main wire rope 24 is wound, and the main hook 20a for suspending the load W. The sub-hook block 21 includes the sub hook 21a for suspending the load W.

The main winch 23 is a device for feeding (winding up) and unfeeding (winding down) the main wire rope 24. The sub winch 25 is a device for feeding (winding up) and unfeeding (winding down) the sub wire rope 26. In the main winch 23, a non-illustrated main hydraulic motor serving as an actuator rotates a main drum around which the main wire rope 24 is wound. In the sub winch 25, a non-illustrated sub hydraulic motor serving as an actuator rotates a sub drum around which the sub wire rope 26 is wound.

The cabin 27 is a housing that covers an operation seat. The cabin 27 is mounted on the slewing table 17. The non-illustrated operation seat is provided in the cabin 27. The operation seat is provided with a traveling-dedicated operation tool 28 for operating and travelling the vehicle 12 and crane-device-dedicated operation tools 29 including, for the crane device 16, a slewing-dedicated operation tool 29a for operating the slewing-dedicated hydraulic motor 17a, a telescopic-movement-dedicated operation tool 29b for operating the telescopic-movement-dedicated hydraulic cylinder 19a, a derricking-movement-dedicated operation tool 29c for operating the derricking-movement-dedicated hydraulic cylinder 22, a main operation tool 29d for operating the main winch 23, and a sub operation tool 29e for operating the sub winch 25, for example (see FIG. 5).

As illustrated in FIG. 5, the crane-dedicated control device 30 controls each of the actuators for the crane 11. The crane-dedicated control device 30 is provided in the cabin 27. A CPU, a ROM, a RAM, and an HDD, for example, are coupled to the crane-dedicated control device 30 through a bus. Alternatively, the crane-dedicated control device 30 includes an LSI in a form of a single chip, for example.

The crane-dedicated control device 30 stores various types of programs and various types of pieces of data for controlling operation of the actuators and switching valves and for processing image data, for example. The crane-dedicated control device 30 has the communication device 30a. The communication device 30a allows information to be transmitted to and received from the image processing device 9 for the maneuvering assistance system 1.

The crane-dedicated control device 30 is coupled to the crane-dedicated GNSS receiver 18. The crane-dedicated control device 30 is capable of acquiring the information Ifb about the position of the crane 11. The crane-dedicated control device 30 is coupled to the traveling-dedicated operation tool 28 and the crane-device-dedicated operation tools 29. The crane-dedicated control device 30 is capable of acquiring operation signals from the traveling-dedicated operation tool 28 and the crane-device-dedicated operation tools 29, respectively.

The crane-dedicated control device 30 generates a control signal for the vehicle 12 based on an operation signal generated as the traveling-dedicated operation tool 28 is operated. Similarly, the crane-dedicated control device 30 generates a control signal for the crane device 16 based on an operation signal generated as the crane-device-dedicated operation tools 29 are operated. The crane-dedicated control device 30 is capable of transmitting the generated control signals to the actuators for the crane device 16, respectively.

The crane-dedicated control device 30 is capable of generating the information Ifc about the posture of the crane 11 from the operation signals acquired from the crane-device-dedicated operation tools 29, respectively. It is assumed that the crane-dedicated control device 30 has stored in advance the information Ifi about the shape of the crane 11 and the information Ifh about the shape of the reference member Rm.

The crane-dedicated control device 30 is coupled to the image processing device 9 in the maneuvering assistance system 1 via the communication device 30a. The crane-dedicated control device 30 is capable of transmitting, to the image processing device 9, the information Ifb about the position of the crane 11, the information Ifc about the posture of the crane 11, the information Ifi about the shape of the crane 11, the information Ifh about the shape of the reference member Rm, and the information Iff about the reference member image P2.

The crane 11 configured as described above is capable of moving the vehicle 12 to a desired position as the traveling-dedicated operation tool 28 is operated. In addition, the crane 11 is capable of carrying the load W to a desired position as the crane-device-dedicated operation tools 29 are operated and the boom 19 is slewed, raised, lowered, extended, and contracted. In addition, the crane 11 is capable of transmitting various types of information to the maneuvering assistance system 1.

<Displaying Current Positions of Boom 19 and Main Hook 20a>

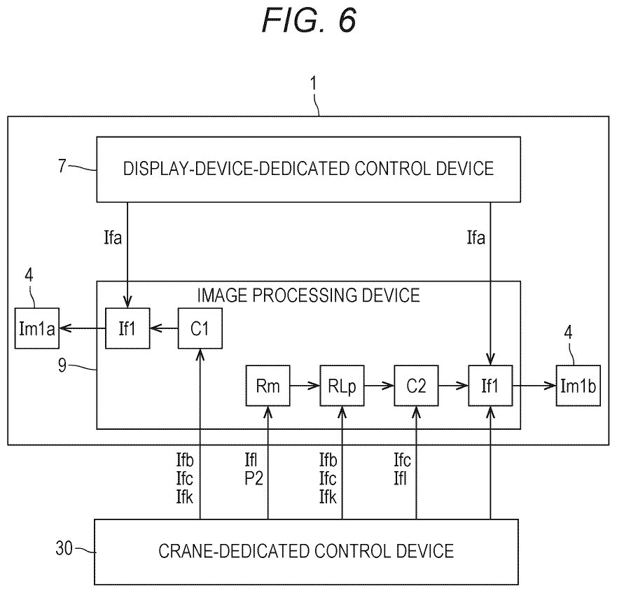

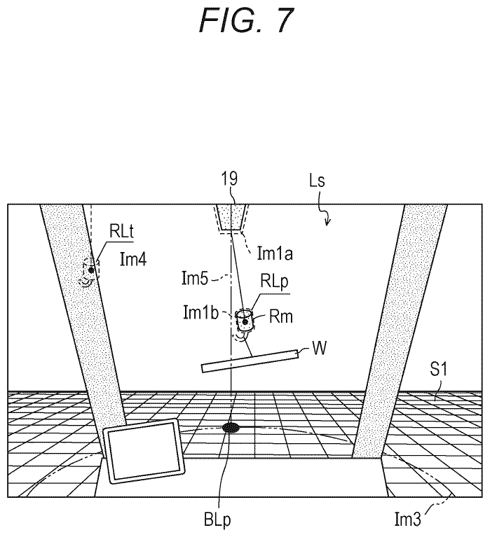

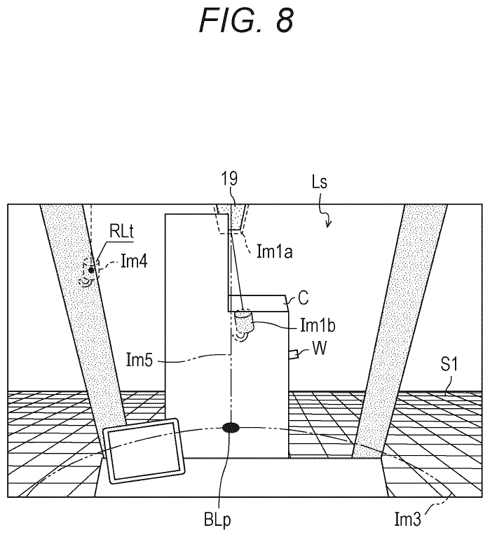

As the first embodiment of the maneuvering assistance system 1 for the operator of the crane 11, how to display current positions of the boom 19, the main hook block 20, and the main hook 20a (hereinafter simply referred to as the “main hook 20a”) will now be specifically described herein with reference to FIGS. 6 to 8. FIG. 6 is a control block diagram when the maneuvering assistance system 1 for the crane 11 displays the first virtual image Im1. FIG. 7 is a schematic view illustrating a state when the maneuvering assistance system 1 for the crane 11 is displaying the first virtual image Im1, the third virtual image Im3, the fourth virtual image Im4, and the fifth virtual image Im5. FIG. 8 is a schematic view illustrating a state when the maneuvering assistance system 1 for the crane 11 is displaying the first boom virtual image Im1a and the first reference member virtual image Im1b in a state where it is impossible to visually recognize a part of the boom 19 and a part of the main hook 20a.

The operator of the crane 11 is also the user of the transmissive display device 2. The operator of the crane 11 maneuvers the crane 11 in a state of wearing the transmissive display device 2 on the head. In addition, the operator of the crane 11 maneuvers the crane 11 in a state of seating in the cabin 27 (see FIG. 4) of the crane 11. In the present embodiment, the reference member Rm is the main hook 20a of the crane 11.

As illustrated in FIG. 6, the image processing device 9 in the maneuvering assistance system 1, which is coupled to the crane-dedicated control device 30 for the crane 11, calculates, based on the information Ifb about the position of the crane 11, the information Ifc about the posture of the crane 11, and the information Ifi about the shape of the crane 11, first reference coordinates C1 representing a set of three-dimensional coordinates of the boom 19 under the current posture of the boom 19. Furthermore, the image processing device 9 generates, based on the information Ifa about the position of the user and the first reference coordinate C1, information If1 about the first virtual image Im1 for displaying, on the display screens of the transmissive displays 4, the first boom virtual image Im1a indicating the shape of the boom 19, when viewed from the viewpoint of the user of the transmissive display device 2. In other words, the image processing device 9 determines a position on the display, at which a virtual image (the first boom virtual image Im1a) is to be displayed, based on the information about the position of the user of the display and the information about the position of the target member, which is calculated based on the posture of the work vehicle and the position of the work vehicle. Then, the image processing device 9 transmits information about the determined positions on the display for displaying the virtual image to the display-device-dedicated control device 7. Note that, when the positions are to be determined in this manner, the information Ifi about the shape of the crane 11 may be omitted.

In addition, the image processing device 9 extracts, based on the information Ifh about the shape of the reference member Rm and the information Iff about the reference member image P2, the reference member Rm from the reference member image P2. Furthermore, the image processing device 9 calculates, based on the reference member Rm extracted from the reference member image P2, the information Ifb about the position of the crane 11, the information Ifc about the posture of the crane 11, and the information Ifi about the shape of the crane 11, a current position RLp of the reference member Rm, including coordinate information including a current latitude, a current longitude, and a current altitude (a height from a distal end of the boom 19) of the reference member Rm and an orientation of the reference member Rm, for example. The current position RLp of the reference member Rm is calculated from a position of the reference member Rm included in the reference member image P2 that the boom camera 19b (see FIG. 5) has captured for each unit time. That is, the current position RLp also includes a change in position due to shaking of the reference member Rm, for example.

The image processing device 9 calculates, based on the current position RLp of the reference member Rm, the information Ifc about the posture of the crane 11, and the information Ifh about the shape of the reference member Rm, second reference coordinates C2 representing a set of three-dimensional coordinates of the reference member Rm at the current position RLp of the reference member Rm. Furthermore, the image processing device 9 generates, based on the information Ifa about the position of the user and the second reference coordinates C2, the information If1 about the first virtual image Im1 for displaying, on the display screens of the transmissive displays 4, the first reference member virtual image Im1b indicating the shape of the reference member Rm, when viewed from the viewpoint of the user of the transmissive display device 2. In other words, the image processing device 9 determines, based on the information about the position of the user of the display and the information about the position of the target member, which is calculated based on the posture of the work vehicle and the position of the work vehicle, a position on the display, at which a virtual image (the first reference member virtual image Im1b) is to be displayed. Then, the image processing device 9 transmits information about the determined positions on the display for displaying the virtual image to the display-device-dedicated control device 7. Note that a method for calculating the current position RLp of the reference member Rm is not limited to the method described above. The current position RLp of the reference member Rm may be calculated based on, for example, information about the position of the crane and information about the posture of the crane.

The image processing device 9 transmits, to the display-device-dedicated control device 7, the generated information If1 about the first virtual image Im1 for displaying, on the display screens of the transmissive displays 4, at least one of the first boom virtual image Im1a and the first reference member virtual image Im1b.

The display-device-dedicated control device 7 acquires the information If1 about the first virtual image Im1 from the image processing device 9 via the communication devices 8.

As illustrated in FIG. 7, the display-device-dedicated control device 7 displays, based on the information If1 about the first virtual image Im1, on the display screens of the transmissive displays 4, where the boom 19 that the user of transmissive display device 2 is visually recognizing through the transmissive displays 4 is superimposed, at least one of the first boom virtual image Im1a indicating the shape of the boom 19, when viewed from the viewpoint of the user of the transmissive display device 2, and the first reference member virtual image Im1b indicating the shape of the reference member Rm, when viewed from the viewpoint of the user. The first boom virtual image Im1a is superimposed on the boom 19 that the user of the transmissive display device 2 is visually recognizing through the transmissive displays 4. The first reference member virtual image Im1b is superimposed on the main hook 20a that is the reference member Rm and that the user of the transmissive display device 2 is visually recognizing through the transmissive displays 4.

As illustrated in FIG. 8, the transmissive display device 2 displays, on the transmissive displays 4, the first boom virtual image Im1a indicating the shape of the boom 19, when viewed from the viewpoint of the user of the transmissive display device 2, even when at least a part of the boom 19 is hidden behind a structure C, for example, and is not visible from the viewpoint of the user of the transmissive display device 2. Similarly, the transmissive display device 2 displays, on the transmissive displays 4, the first reference member virtual image Im1b indicating the shape of the reference member Rm, when viewed from the viewpoint of the user of the transmissive display device 2, even when at least a part of the reference member Rm is hidden behind the structure C, for example, and is not visible from the viewpoint of the user of the transmissive display device 2. That is, when a target member is hidden behind an obstacle and is not visible, the display-device-dedicated control device 7 displays, on the transmissive displays 4, a virtual image (specifically, the first boom virtual image Im1a and the first reference member virtual image Im1b) in a superimposed manner on the obstacle.

As described above, the image processing device 9 generates, based on the information Ifa about the position of the user, the information Ifb about the position of the crane 11, the information Ifc about the posture of the crane 11, and the information Ifi about the shape of the crane 11, the information If1 about the first virtual image Im1 for displaying the first boom virtual image Im1a. In addition, the image processing device 9 generates, based on the information Ifa about the position of the user, the information Ifb about the position of the crane 11, the information Ifc about the posture of the crane 11, the information Ifh about the shape of the reference member Rm, and the reference member image P2, the information If1 about the first virtual image Im1 for displaying the first reference member virtual image Im1b.

That is, when generating the information If1 about the first virtual image Im1, the image processing device 9 does not utilize image information including the boom 19 and the reference member Rm, when viewed from the viewpoint of the user of the transmissive display device 2.

Therefore, the image processing device 9 is capable of generating the information If1 about the first virtual image Im1 for displaying the first boom virtual image Im1a and the first reference member virtual image Im1b even when at least a part of the boom 19 and a part of the reference member Rm is hidden, when viewed from the viewpoint of the user of the transmissive display device 2.

Even when it is not possible to visually recognize the boom 19 or the main hook 20a suspending the load W from inside the cabin 27 while carrying the load W, at least one of the first boom virtual image Im1a and the first reference member virtual image Im1b allows the operator of the crane 11, who is using the transmissive display device 2, to carry out maneuvering while objectively grasping a positional relationship among a surrounding structure C, the boom 19, and the main hook 20a. Thereby, it is possible to suppress an influence of information acquired from the instructor on maneuvering and to efficiently maneuver the crane 11.

<Second Embodiment: Displaying Image that Boom Camera Captures>

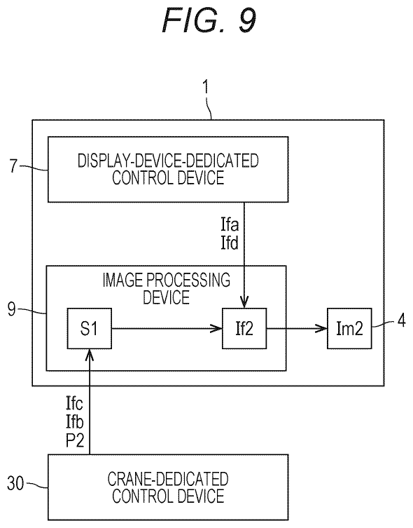

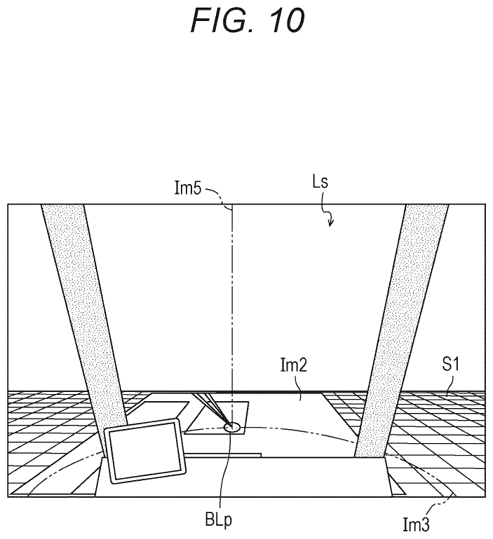

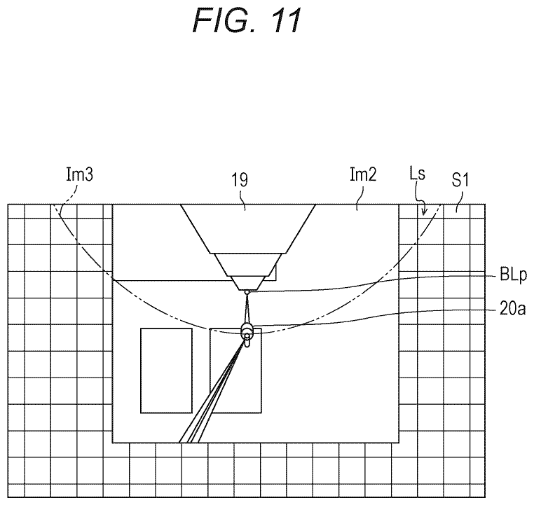

As a second embodiment of the maneuvering assistance system 1 for the operator of the crane 11, how to display an image that the boom camera 19b captures on a desired reference plane S1 will now be specifically described herein with reference to FIGS. 9 to 11. FIG. 9 is a block diagram when the maneuvering assistance system 1 for the crane 11 generates the information If2 about second virtual image necessary for displaying the second virtual image Im2. FIG. 10 is a schematic view illustrating a state when the maneuvering assistance system 1 for the crane 11 is displaying the second virtual image Im2 when a ground plane is set as the reference plane S1. FIG. 11 is a schematic view illustrating a state when the maneuvering assistance system 1 for the crane 11 is displaying the second virtual image Im2 when a horizontal plane including a current position BLp of the distal end of the boom is set as the reference plane S1.

As illustrated in FIG. 9, the maneuvering assistance system 1 for the crane 11 displays, on the transmissive display device 2 (see FIG. 3), as the second virtual image Im2 on the desired reference plane S1, the reference member image P2 that is an image of a predetermined range including the reference member Rm, which the boom camera 19b that the boom 19 includes captures.

The display-device-dedicated control device 7 for the transmissive display device 2 has the information Ifa about the position of the user and information Ifd about the reference plane S1. The information Ifd about the reference plane S1 includes a position and an inclination of a virtual plane serving as a reference for a position at which the second virtual image Im2, when viewed from the viewpoint of the user, is to be displayed. In the present embodiment, the reference plane S1 is at least one of the ground plane and the horizontal plane including the current position BLp of the distal end of the boom 19, and is set in advance within the background (the landscape) Ls. Note that, the user may determine the reference plane S1 as desired.

The image processing device 9 coupled to the display-device-dedicated control device 7 via the communication devices 8 acquires the information Ifa about the position of the user from the display-device-dedicated control device 7. In addition, the image processing device 9 coupled to the crane-dedicated control device 30 via the communication device 8 acquires, from the crane-dedicated control device 30, the reference member image P2 that the boom camera 19b captures, the information Ifb about the position of the crane 11, and the information Ifc about the posture of the crane 11. The image processing device 9 determines the reference plane S1 from the acquired information Ifa about the position of the user, the acquired information Ifb about the position of the crane 11, and the acquired information Ifc about the posture of the crane 11.

As illustrated in FIG. 10, when it is determined that a direction of visual recognition of the user is downward than a horizontal direction based on the information Ifa about the position of the user, the image processing device 9 sets the ground plane as the reference plane S1. That is, the image processing device 9 sets the reference plane based on the direction of visual recognition of the user of the display.

As illustrated in FIG. 11, when it is determined that a direction of visual recognition of the user is upward than the horizontal direction based on the information Ifa about the position of the user, the image processing device 9 sets the horizontal plane including the current position BLp of the distal end of the boom 19 as the reference plane S1.

As illustrated in FIG. 9, when the reference plane S1 is the horizontal plane including the current position BLp, that is, when the reference plane S1 is higher in position than the line of sight of the user in the horizontal direction, the image processing device 9 generates the information If2 about the second virtual image Im2 for displaying, on the display screens of the transmissive displays 4, as the second virtual image Im2, an image in which a front and a back of the reference member image P2 are inverted. When the reference plane S1 is the ground plane, that is, when the reference plane S1 is lower in position than the line of sight of the user in the horizontal direction, the image processing device 9 generates the information If2 about the second virtual image Im2 for displaying, on the display screens of the transmissive displays 4, as the second virtual image Im2, an image in which the front and the back of the reference member image P2 are not inverted.

As illustrated in FIGS. 10 and 11, the display-device-dedicated control device 7 for the transmissive display device 2 acquires the reference member image P2 and the information If2 about the second virtual image Im2 from the image processing device 9 via the communication devices 8. Furthermore, the display-device-dedicated control device 7 displays, on the reference surface S1 displayed on the display screens of the transmissive displays 4, the second virtual image Im2, when viewed from the viewpoint of the user.

In the configuration described above, the maneuvering assistance system 1 for the crane 11 generates the information If2 about the second virtual image Im2 for displaying the reference member image P2 that the boom camera 19b provided on the boom 19 captures as the second virtual image Im2 that is an image, when viewed from the viewpoint of the user of the transmissive display device 2, on the background Ls in the transmissive display device 2, which the operator of the crane 11, who is also the user of the transmissive display device 2, is visually recognizing. The maneuvering assistance system 1 displays the second virtual image Im2 on the display screens of the transmissive displays 4 in a superimposed manner on the desired reference plane S1 that the user designates. When an image of the main hook 20a that moves as the boom 19 moves is included, the second virtual image Im2 is displayed to allow the image of the main hook 20a to be superimposed on the main hook 20a when viewed in a perpendicular direction. The operator of the crane 11 is capable of utilizing the second virtual image Im2 on the reference plane S1 as a projection view of the main hook 20a.

Therefore, even in a state where an instruction from the instructor is insufficient and it is impossible to visually recognize a state of the ground plane, displaying the second virtual image Im2 within the field of view of the operator allows the operator of the crane 11 to supplement information about a positional relationship among the boom 19, the main hook 20a, and a surrounding structure C, which is necessary for maneuvering the boom 19. Thereby, the operator of the crane 11 is capable of suppressing an influence of information acquired from the instructor on maneuvering and to efficiently maneuver the crane 11.

### <Third Embodiment: Displaying Current Position BLp and Trajectory of Distal End of Boom 19>

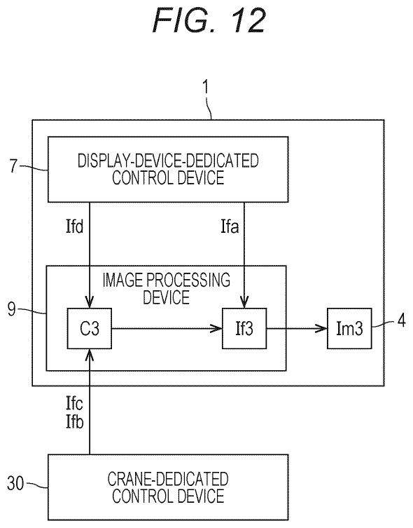

As a third embodiment of the maneuvering assistance system 1 for the operator of the crane 11, how to display a trajectory at the current position BLp of the distal end of the boom 19 will now be specifically described herein with reference to FIGS. 7, 8, and 12. FIG. 12 is a control block diagram when the maneuvering assistance system 1 for the crane 11 displays the third virtual image Im3.

As illustrated in FIG. 7, the maneuvering assistance system 1 for the crane 11 displays, on the transmissive display device 2 (see FIG. 3), as the third virtual image Im3 on the reference plane S1, the distal end of the boom 19, which the crane device 16 moves as the crane-device-dedicated operation tools 29 are operated, and a trajectory of the distal end of the boom 19 at the current position BLp. That is, the third virtual image Im3 includes an image indicating the trajectory of a distal end portion of the boom, which corresponds to the posture of the boom. The third virtual image Im3 is an image included in a virtual image indicating a target member.

The display-device-dedicated control device 7 has the information Ifd about the reference plane S1. In the present embodiment, the ground plane serves as the reference plane S1.

As illustrated in 12, the image processing device 9 is capable of acquiring the information Ifd about the reference plane S1 from the display-device-dedicated control device 7 via the communication devices 8. The information Ifd about the reference plane S1 includes a position and an inclination of a virtual plane serving as a reference for a position at which the third virtual image Im3, when viewed from the viewpoint of the user, is to be displayed.

The image processing device 9 acquires the information Ifb about the position of the crane 11 and the information Ifc about the posture of the crane 11 from the crane-dedicated control device 30. The image processing device 9 calculates, based on the acquired information Ifb about the position of the crane 11, the acquired information Ifc about the posture of the crane 11, and the acquired information Ifd about the reference plane S1, third reference coordinates C3 representing a set of coordinates for displaying, on the reference plane S1, the current position BLp of the distal end of the boom 19 and the coordinates of the trajectory of the boom 19 from the current position BLp, when the crane-device-dedicated operation tools 29 are operated.

Furthermore, the image processing device 9 generates, based on the information Ifa about the position of the user and the third reference coordinates C3, the information If3 about the third virtual image Im3 for displaying, on the display screens of the transmissive displays 4, the third virtual image Im3 indicating the current position BLp of the boom 19, when viewed from the viewpoint of the user of the transmissive display device 2, and the trajectory at the current position BLp.

The image processing device 9 transmits the generated information If3 about the third virtual image Im3 to the display-device-dedicated control device 7.

The transmissive display device 2 acquires the information If3 about the third virtual image Im3 from the image processing device 9 via the communication devices 8.

As illustrated in FIG. 7, the transmissive display device 2 displays the third virtual image Im3 in addition to the first virtual image Im1. Based on the information If3 about the third virtual image Im3, the transmissive display device 2 displays, on the display screens of the transmissive displays 4, the third virtual image Im3 indicating the current position BLp of the boom 19, when viewed from the viewpoint of the user of the transmissive display device 2, and the trajectory at the current position BLp.

The third virtual image Im3 is displayed in a superimposed manner on the reference plane S1 that the user of the transmissive display device 2 is visually recognizing through the transmissive displays 4. When the ground plane serves as the reference surface S1, the display-device-dedicated control device 7 displays, on the display screens of the transmissive displays 4, as the third virtual image Im3, the current position BLp of the boom 19 on the ground plane, when viewed from the viewpoint of the user, and the trajectory from the current position BLp, which is superimposed on the ground plane that the user of the transmissive display device 2 is visually recognizing through the transmissive displays 4.

As illustrated in FIG. 8, the user of the transmissive display device 2 visually recognizes the current position BLp of the distal end of the boom 19 and the trajectory from the current position BLp, which the transmissive display device 2 displays on the ground plane in a work site, which is the actual background Ls. The operator who is also the user of the transmissive display device 2 is capable of confirming, from the third virtual image Im3 displayed on the ground plane, the current position BLp of the distal end of the boom 19 and the trajectory from the current position BLp even in a state where it is impossible to visually recognize the distal end of the boom 19 or the reference member Rm from the operation seat due to a structure C, for example.

As illustrated in FIGS. 7 and 8, the maneuvering assistance system 1 displays the first virtual image Im1 and the third virtual image Im3 on the background Ls within the field of view of the user of the transmissive display device 2, thereby providing the user of the transmissive display device 2 with information for grasping the current position BLp of the distal end of the boom 19, the current position RLp of the main hook 20a, and a positional relationship among the boom 19, the main hook 20a, and a structure C. In addition, the maneuvering assistance system 1 displays, within the field of view of the user of the transmissive display device 2, the current position BLp of the boom 19 in a direction and from a position that the user of the transmissive display device 2 desires and the trajectory from the current position BLp.

Therefore, even when an instruction from the instructor in charge of slinging is insufficient, the current position BLp of the boom 19 and the trajectory from the current position BLp, which are displayed within the field of view of the user of the transmissive display device 2, allows the user of the transmissive display device 2 to supplement information necessary for maneuvering the crane 11. Thereby, the user of the transmissive display device 2 is capable of suppressing an influence of information acquired from the instructor on maneuvering and to efficiently maneuver the crane 11.

### <Fourth Embodiment: Displaying Target Position RLt for Reference Member Rm>

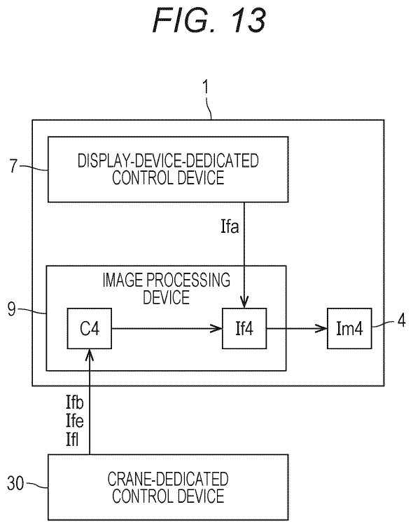

As a fourth embodiment of the maneuvering assistance system 1 for the operator of the crane 11, how to display a target position RLt for the reference member Rm will now be specifically described herein with reference to FIGS. 7 and 13. FIG. 13 is a block diagram when the maneuvering assistance system 1 for the crane 11 generates the information necessary for displaying the fourth virtual image Im4.

As illustrated in FIG. 7, the maneuvering assistance system 1 for the crane 11 displays, as the fourth virtual image Im4, the shape of the reference member Rm at the target position RLt for the reference member Rm.

As illustrated in FIG. 13, the image processing device 9 acquires, from an external server or the crane-dedicated control device 30 via the communication devices 8, the information Ifb about the position of the crane 11, information Ife about the target position RLt for the reference member Rm, and the information Ifh about the shape of the reference member Rm. The information Ife about the target position RLt for the reference member Rm is coordinate information including a latitude, a longitude, and an altitude of the target position RLt for the reference member Rm (corresponding to an amount of feeding from the distal end of the boom 19), for example.

The image processing device 9 calculates, based on the information Ifb about the position of the crane 11, the information Ife about the target position RLt for the reference member Rm, and the information Ifh about the shape of the reference member Rm, fourth reference coordinates C4 representing a set of three-dimensional coordinates of the reference member Rm at the target position RLt. Furthermore, the image processing device 9 generates, based on the information Ifa about the position of the user and the fourth reference coordinates C4, the information If4 about the fourth virtual image Im4 for displaying, on the display screens of the transmissive displays 4, the fourth virtual image Im4 indicating the shape of the reference member Rm at the target position RLt, when viewed from the viewpoint of the user of the transmissive display device 2.

The image processing device 9 transmits the generated information If4 about the fourth virtual image Im4 to the display-device-dedicated control device 7.

The display-device-dedicated control device 7 acquires the information If4 about the fourth virtual image Im4 from the image processing device 9 via the communication devices 8.

As illustrated in FIG. 7, based on the information If4 about the fourth virtual image Im4, the display-device-dedicated control device 7 displays, on the display screens of the transmissive displays 4, the fourth virtual image Im4 indicating the shape of the reference member Rm, when viewed from the viewpoint of the user of the transmissive display device 2. The fourth virtual image Im4 is displayed at the target position RLt for the reference member Rm, which the user of the transmissive display device 2 is visually recognizing through the transmissive displays 4.

In addition, as illustrated in FIG. 7, based on the information If1 about the first virtual image Im1, the transmissive display device 2 displays, on the display screens of the transmissive displays 4, the first reference member virtual image Im1b indicating the shape of the reference member Rm at the current position RLp, when viewed from the viewpoint of the user of the transmissive display device 2. The first reference member virtual image Im1b is superimposed on the main hook 20a that is the reference member Rm and that the user of the transmissive display device 2 is visually recognizing through the transmissive displays 4.

The transmissive display device 2 displays, on the transmissive displays 4, the fourth virtual image Im4 indicating the shape at the reference member Rm on the target position RLt, when viewed from the viewpoint of the user of the transmissive display device 2, even when the target position RLt for the reference member Rm is hidden behind a structure C, for example, and is not visible from the viewpoint of the user of the transmissive display device 2.

Even when the target position RLt for the reference member Rm is hidden behind a structure C, for example, and is not visible from the viewpoint of the user of the transmissive display device 2, the operator of the crane 11, who is using the transmissive display device 2, is capable of carrying out maneuvering while objectively grasping a positional relationship between the current position RLp of and the target position RLt for the reference member Rm and a positional relationship between the surrounding structure C and the reference member Rm at the current position RLp and the target position RLt. Therefore, even when an instruction from the instructor is insufficient, the operator is capable of supplementing information necessary for moving the reference member Rm positioned at the current position RLp to the target position RLt for the reference member Rm, which is displayed within the field of view of the operator. Thereby, it is possible to suppress an influence of information acquired from the instructor on maneuvering and to efficiently maneuver the crane 11. Note that, the fourth virtual image Im4 may include a virtual image indicating the boom 19 and/or a wire rope (the main wire rope 24 and/or the sub wire rope 26). That is, the display-device-dedicated control device 7 may display, on the transmissive displays 4, a virtual image indicating the boom 19 and/or a wire rope (the main wire rope 24 and/or the sub wire rope 26) at the positions of the boom 19 and/or the wire rope (the main wire rope 24 and/or the sub wire rope 26), which correspond to the target position RLt for the reference member Rm.

### <Fifth Embodiment: Displaying Perpendicular Line at Current Position BLp of Boom 19>

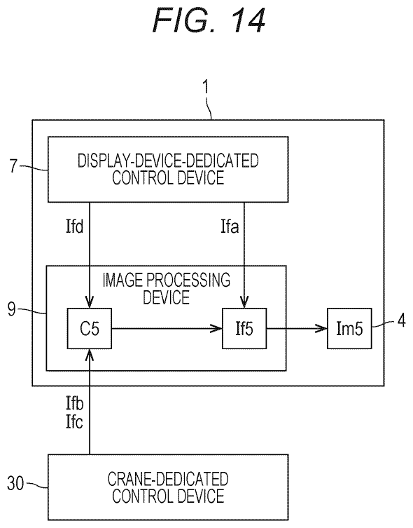

Next, as a fifth embodiment of the maneuvering assistance system 1 for the operator of the crane 11, how to display a perpendicular line passing through the current position BLp of the boom 19 will now be specifically described herein with reference to FIGS. 7, 8, and 14. FIG. 14 is a block diagram when the maneuvering assistance system 1 for the crane 11 generates information necessary for displaying the fifth virtual image Im5.

As illustrated in FIG. 7, the maneuvering assistance system 1 for the crane 11 displays, as the fifth virtual image Im5, a perpendicular line passing through the current position BLp of the boom 19.

As illustrated in FIG. 14, the image processing device 9 calculates, based on the acquired information Ifb about the position of the crane 11, the acquired information Ifc about the posture of the crane 11, and the acquired information Ifd about the reference plane S1, fifth reference coordinates C5 representing a set of coordinates for displaying a perpendicular line passing through the current position BLp of the boom 19. The image processing device 9 generates, based on the acquired information Ifa about the position of the user and the acquired fifth reference coordinates C5, the fifth reference coordinates C5 as the information If5 about the fifth virtual image Im5, when viewed from the viewpoint of the user of the transmissive display device 2. The image processing device 9 transmits the generated information If5 about the fifth virtual image Im5 to the display-device-dedicated control device 7.

The display-device-dedicated control device 7 acquires the information If5 about the fifth virtual image Im5 via the communication devices 8. Based on the information If5 about the fifth virtual image Im5, the display-device-dedicated control device 7 displays, on the display screens of the transmissive displays 4, the fifth virtual image Im5 indicating the perpendicular line passing through the current position BLp of the boom 19, when viewed from the viewpoint of the user of the transmissive display device 2, to serve as the fifth virtual image Im5.

As illustrated in FIGS. 7 and 8, the user of the transmissive display device 2 visually recognizes the current position BLp of the boom 19 from the fifth virtual image Im5 indicating the current position BLp of the boom 19, which the transmissive display device 2 displays on the actual background Ls. When both the fourth virtual image Im4 indicating the shape at the target position RLt on the reference member Rm and the fifth virtual image Im5 are displayed, the user of the transmissive display device 2 is capable of recognizing a positional relationship between the current position BLp of the boom 19 and the target position RLt for the reference member Rm even in a state where it is impossible to visually recognize the boom 19 from the operation seat. Thereby, the user of the transmissive display device 2 is capable of suppressing an influence of information acquired from the instructor on maneuvering and to efficiently maneuver the crane 11, even when an instruction from the instructor is insufficient.

### OTHER EMBODIMENTS

In each of the embodiments described above, the maneuvering assistance system 1 for the crane 11 causes the transmissive display device 2 to display any one of the first virtual image Im1, the second virtual image Im2, the third virtual image Im3, the fourth virtual image Im4, and the fifth virtual image Im5. However, the maneuvering assistance system 1 for the crane 11 may urge the user of the transmissive display device 2 to select and display at least one of the first virtual image Im1, the second virtual image Im2, the third virtual image Im3, the fourth virtual image Im4, and the fifth virtual image Im5. In addition, the maneuvering assistance system 1 for the crane 11 may display a virtual image for assisting maneuvering of a work vehicle, in addition to virtual images displayed in the embodiments described above.

In addition, as the embodiments described above, the operator who maneuvers the crane 11 in the cabin 27 of the crane 11 wears the transmissive display device 2 for the maneuvering assistance system 1. However, an operator who remotely operates the crane 11 from outside of the crane 11 may wear the transmissive display device 2. For example, when a slinging operator is wearing the transmissive display device 2, the slinging operator causes the transmissive display device 2 to display the first virtual image Im1 and the second virtual image Im2, making it possible to inform the user of the transmissive display device 2 for the crane 11 of the position of the boom 19 or the reference member Rm even when the boom 19 or the reference member Rm is hidden behind a structure C, for example.

In addition, as illustrated in FIG. 10, the transmissive display device 2 for the maneuvering assistance system 1 displays the third virtual image Im3 indicating the current position BLp of the boom 19 and the trajectory at the current position BLp on the reference plane S1 on which the second virtual image Im2 is displayed. However, the third virtual image Im3 may be displayed on a desired reference plane on which the second virtual image Im2 is not displayed. In addition, in the case where the load W being carried serves as the reference member Rm, for example, a third virtual image may be displayed as a trajectory passing through the load W.

In addition, as the embodiments described above, the maneuvering assistance system 1 is configured as the maneuvering assistance system 1 for the crane 11. However, the maneuvering assistance system may be configured as a maneuvering assistance system for a high-place work vehicle that is a work vehicle. The maneuvering assistance system for the high-place work vehicle acquires, via a communication device, information about a position of a user, information about a position of the high-place work vehicle, information about a posture of the high-place work vehicle, and information about a reference plane including a position and a posture of the reference plane serving as a reference for displaying a virtual image. The image processing device for the maneuvering assistance system generates information about a virtual image of a bucket for displaying, on a display screen of a transmissive display device, a current position of the bucket serving as a reference member and a trajectory from the current position, as a virtual image, when viewed from the viewpoint of the operator of the high-place work vehicle. The transmissive display device acquires information about the virtual image of the bucket for the high-place work vehicle via the communication device, and displays the virtual image on the display screen.

In addition, in each of the embodiments described above, the maneuvering assistance system 1 for the crane 11 causes the transmissive display device 2 to display at least one of the first virtual image Im1, the second virtual image Im2, the third virtual image Im3, the fourth virtual image Im4, and the fifth virtual image Im5. However, the maneuvering assistance system 1 for the crane 11 may display, on an image that a camera has captured, at least one of the first virtual image Im1, the second virtual image Im2, the third virtual image Im3, the fourth virtual image Im4, and the fifth virtual image Im5. At least one of the first virtual image Im1, the second virtual image Im2, the third virtual image Im3, the fourth virtual image Im4, and the fifth virtual image Im5 may be operable on a display screen such as a touch panel.

In addition, in the embodiments described above, the image processing device 9 acquires the information Ife about the target position RLt for the reference member Rm from an external server or the crane-dedicated control device 30 via the communication devices 8. However, in the image processing device 9, the user of the transmissive display device 2 may acquire the information Ife about the target position RLt via an input device, for example. In the image processing device 9, the transmissive display device 2 may be used as an input device, for example, and the target position RLt for the reference member Rm may be inputted.

In addition, in the embodiments described above, the image processing device 9 acquires the information Ifg about the posture of the reference member Rm from the reference member image P2 that the boom camera 19b captures. However, the image processing device 9 may externally acquire the information Ifg about the posture of the reference member Rm. The image processing device 9 may acquire the information Ifg about the posture of the reference member Rm, for example, from an image transmitted from a camera provided outside the crane 11 via the communication devices 8.

In addition, in the embodiments described above, the image processing device 9 acquires, via the communication devices 8, the information Ifi about the shape of the crane 11, the information Ifa about the position of the user, the information Ifb about the position of the crane 11, the information Ifc about the posture of the crane 11, the information Ifh about the shape of the reference member Rm that moves as the boom 19 moves, and the information Ifg about the posture of the reference member Rm. However, the image processing device may be configured to acquire at least one of these pieces of information.

In addition, in each of the embodiments described above, the transmissive display device 2 recognizes a marker positioned at a certain position to calculate the information Ifa about the position of the user, which is necessary for displaying a virtual image on the transmissive displays 4. However, the transmissive display device may calculate the information Ifa about the position of the user from the position of the transmissive display device 2, which the GNSS receiver detects.

In addition, in each of the embodiments described above, the transmissive display device 2 is a wearable terminal that the user wears on its body and uses. However, it may be sufficient that the transmissive display device be a display device that allows a virtual image, when viewed from the viewpoint of the user, to be superimposed and visually recognized on a display screen that allows a background to be transmitted, when viewed from the viewpoint of the user. It may be sufficient that the transmissive display device be, for example, a head-up display that uses a windshield for the cabin as a display screen to display a virtual image, when viewed from the viewpoint of the user of the transmissive display device 2, who is seating on the operation seat.

In addition, in each of the embodiments described above, the transmissive display device 2 uses the inertial measurement unit 5 to calculate a direction of movement and an amount of movement. However, the transmissive display device may calculate a direction of movement and an amount of movement through visual simultaneous localization and mapping (Visual SLAM) that generates, based on image data, a map of a surrounding environment and estimates its position. In Visual SLAM, feature points in an image acquired from a stereo camera, for example, are grasped. Next, in Visual SLAM, its position is estimated and a map is created from movement of the feature points as the stereo camera moves, for example. The transmissive display device is capable of utilizing an image that the display-device-dedicated camera that captures an image in a direction of the line of sight of the user has captured to calculate a direction of movement and an amount of movement.

The embodiments described above are mere representative forms, and it is possible to apply various types of modifications without departing from the gist of each of an embodiments. It is obvious that it is possible to further implement the present invention in various types of forms, the scope of the present invention is defined as described in the claims, and, furthermore, the present invention includes equivalent meanings described in the claims and all modifications falling within the scope.

This application is based upon and claims the benefit of priority from Japanese Patent Application No. 2021-194526, filed on Nov. 30, 2021, the entire contents of which are incorporated herein by reference.

### INDUSTRIAL APPLICABILITY

The present invention is applicable to various types of work machines having a boom.

### REFERENCE SIGNS LIST

1 Maneuvering assistance system
2 Transmissive display device
3 Frame
4 Transmissive display
5 Inertial measurement unit
6 Display-device-dedicated camera
7 Display-device-dedicated control device
8 Communication device
9 Image processing device
11 Crane
12 Vehicle
13 Wheel
14 Engine
15 Outrigger
16 Crane device
17 Slewing table
17a Slewing-dedicated hydraulic motor
18 Crane-dedicated GNSS receiver
19 Boom
19a Telescopic-movement-dedicated hydraulic cylinder
19b Boom camera
19c Jib
20 Main hook block
20a Main hook (reference member)
21 Sub hook block
21a Sub hook
22 Derricking-movement-dedicated hydraulic cylinder
23 Main winch
24 Main wire rope
25 Sub winch
26 Sub wire rope
27 Cabin
28 Traveling-dedicated operation tool
29 Crane-device-dedicated operation tool
29a Slewing-dedicated operation tool
29b Telescopic-movement-dedicated operation tool
29c Derricking-movement-dedicated operation tool
29d Main operation tool
29e Sub operation tool
30 Crane-dedicated control device
30a Communication device
BLp Current position of boom
RLt Current position of reference member
RLt Target position for reference member
S1 Reference plane
Rm Reference member
Ifa Information about position of user
Ifb Information about position of crane
Ifc Information about posture of crane
Ifd Information about reference plane
Ife Information about target position for reference member
Iff Information about reference member image
Ifg Information about posture of reference member
Ifh Information about shape of reference member
Ifi Information about shape of crane
Im1 First virtual image
Im1a First boom virtual image
Im1b First reference member virtual image
Im2 Second virtual image
Im3 Third virtual image
Im4 Fourth virtual image
Im5 Fifth virtual image
C1 First reference coordinate
If1 Information about first virtual image
If2 Information about second virtual image
If3 Information about third virtual image
If4 Information about fourth virtual image
If5 Information about fifth virtual image

1. A maneuvering assistance system that assists maneuvering of a work vehicle including a boom, the maneuvering assistance system comprising:
a display that is transparent and that is capable of displaying an image;
a generation unit that generates a virtual image indicating a target member including the boom and/or a member that moves together with the boom; and
a control unit that displays the virtual image on the display in a superimposed manner on a landscape visible through the display in a mode in which a user of the display is capable of recognizing a position of the target member.

2. The maneuvering assistance system according to claim 1, wherein
the target member is the boom and/or a hook that moves together with the boom, and
the control unit displays the virtual image on the display at a portion coinciding with the position of the target member.

3. The maneuvering assistance system according to claim 2, wherein
the virtual image is an image representing a shape of the target member.

4. The maneuvering assistance system according to claim 2, wherein
the control unit displays the virtual image on the display so as to, when the target member is hidden behind an obstacle and is not visible, be superimposed on the obstacle.

5. The maneuvering assistance system according to claim 1, wherein
the control unit displays the virtual image at a position on the display, the position being determined based on information about a position of the user of the display and information about the position of the target member, the position of the target member being calculated based on a posture of the work vehicle and a position of the work vehicle.

6. The maneuvering assistance system according to claim 5, wherein
the generation unit determines the position on the display and transmits information including the determined position on the display to the control unit.

7. The maneuvering assistance system according to claim 1, wherein
the target member that the virtual image indicates is a hook that moves together with the boom,
the virtual image is an image that has been captured by a camera that captures the hook from a distal end portion of the boom, and
the control unit displays the virtual image on the display in a superimposed manner on a reference plane set on the landscape.

8. The maneuvering assistance system according to claim 7, wherein
the generation unit sets, as the reference plane, a ground plane on the landscape or a horizontal plane including a position of a distal end of the boom.

9. The maneuvering assistance system according to claim 8, wherein
the generation unit sets the reference plane based on a direction of visual recognition of the user of the display.

10. The maneuvering assistance system according to claim 1, wherein
the virtual image includes a virtual image indicating a trajectory of a distal end portion of the boom, the trajectory corresponding to a posture of the boom, and
the control unit displays the virtual image indicating the trajectory in a superimposed manner on the reference plane set on the landscape.

11. The maneuvering assistance system according to claim 2, wherein
the control unit displays the virtual image on the display at a portion coinciding with a target position for the target member.

12. The maneuvering assistance system according to claim 2, wherein
the virtual image includes a virtual image indicating a perpendicular line passing through a distal end portion of the boom, and
the control unit displays the virtual image indicating the perpendicular line on the display at a portion corresponding to the distal end portion of the boom.

13. A work vehicle comprising the maneuvering assistance system according to claim 1.
